(19) United States
(12) Patent Application Publication
(10) Pub. No.: US 2010/0103142 A1
(43) Pub. Date: Apr. 29, 2010

(54) ELECTRONIC DEVICE WITH INFRARED TOUCH INPUT FUNCTION

(75) Inventors: XIN ZHAO, Shenzhen City (CN); ZU-PEI HE, Shenzhen City (CN); RUEY-SHYANG YOU, Tu-Cheng (TW); HUA-DONG CHENG, Shenzhen City (CN); HAN-CHE WANG, Tu-Cheng (TW); KUAN-HONG HSIEH, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/545,874

(22) Filed: Aug. 24, 2009

(30) Foreign Application Priority Data
Oct. 23, 2008 (CN) 200810305100.X

(51) Int. Cl. G06F 3/042

(52) U.S. Cl. 345/175

(57) ABSTRACT

An electronic device with infrared touch input function is provided. The electronic device includes a display unit defining an information display area; an infrared input device comprising a circuit board having two pairs of oppositely disposed sides defining an open area corresponding in size and shape to the information display area, at least one light emitting device positioned on one corner of the circuit board; a linear array of light detecting devices positioned on one side or two adjacent sides of the circuit board and faced to light emitting devices; and a micro-processing unit configured for determining whether the light detecting device receives the infrared light emitted by the light emitting device; and a central processing unit(CPU) configured for controlling the display unit displaying a plurality of menu options, determining whether the menu option is touched; and performing functions corresponding to the menu option when the menu option is touched.

### BACKGROUND

1. Related Applications

This application is related to copending applications entitled, “ELECTRONIC DEVICE WITH INFRARED TOUCH INPUT FUNCTION”, filed ______ (Atty. Docket No. US 23304); “ELECTRONIC DEVICE WITH INFRARED TOUCH INPUT FUNCTION”, filed ______ (Atty. Docket No. US23308); and “ELECTRONIC DEVICE WITH INFRARED TOUCH INPUT FUNCTION”, filed ______ (Atty. Docket No. US24653).

2. Technical Field

The disclosure relates to electronic devices with an input function and, particularly, to an electronic device with infrared touch input function.

3. General Background

It is well known that an infrared input system comprises a circuit board having a first pair of opposed sides positioned parallel to a first axis and a second pair of opposed sides positioned parallel to a second axis, the second axis being perpendicular to the first axis, each of the second pair of sides connecting the first pair of sides, all four sides defining a generally rectangular touch input area, a linear array of light emitting devices along each side, and a light detection device positioned at each corner of the circuit board; and a controller coupled to the light emitting devices and the light detection devices, wherein the controller sequentially activates each linear array and activates the light detection devices positioned at corners of the circuit board opposed to the activated array of light emitting devices. The system can discern the location of a touch within the information display area by implementing an algorithm on x, y coordinates detected by the detectors, which is complicated and time consuming.

Therefore, it is necessary to provide a electronic device with infrared touch input function to implement the functions in a simpler way.

### BRIEF DESCRIPTION OF THE DRAWINGS

FIG. 1 is an exploded, schematic view showing an electronic device with an infrared touch input function in accordance with a first exemplary embodiment.

FIG. 2 is a schematic diagram showing the electronic device of FIG. 1.

FIG. 3 is a block diagram showing an internal configuration of the electronic device of FIG. 1.

FIG. 4 is a flowchart implemented by the electronic device of FIG. 2 in one circular scan, in accordance with an embodiment.

### DETAILED DESCRIPTION

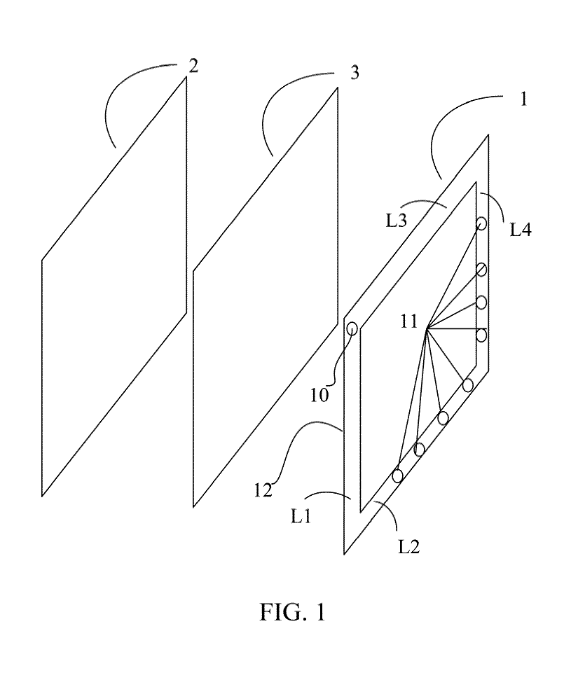

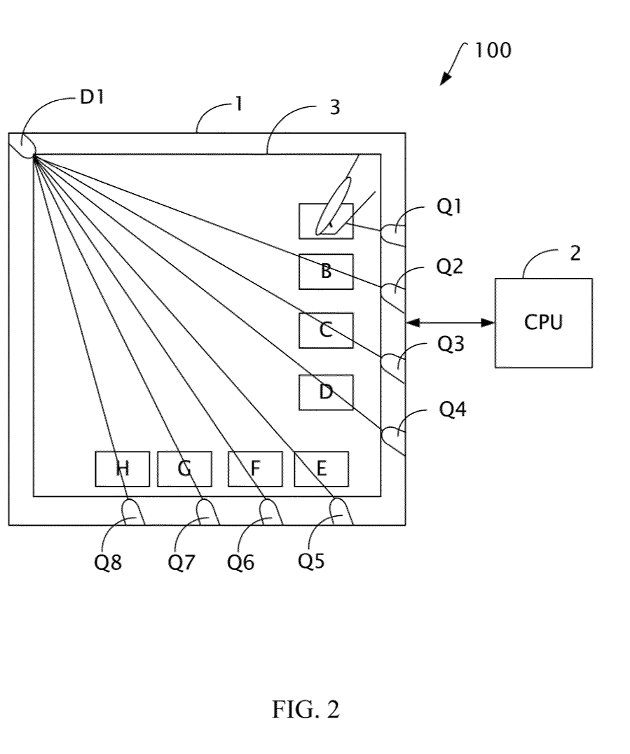

Referring to FIGS. 1-2, the electronic device 100 includes an infrared input device 1, a central processing unit (CPU) 2, and a display unit 3.

The CPU 2 is electronically connected to the infrared input device 1 and the display unit 3. The display unit 3 may be a flat panel display defining an information display area. The infrared input device 1 may include a circuit board 12 having two pairs of oppositely disposed sides(L1, L2, L3, and L4) defining an open area corresponding in size and shape to the information display area. The circuit board 12 includes at least one light emitting device 10 and a linear array of light detecting devices 11 (Q1-Q8). In an exemplary embodiment, the light emitting devices 10 are organic light emitting diodes that emit light in the infrared (IR) range (D1), and the light detecting devices 11 are light phototransistors (Q1-Q8). The light detecting devices 11 can be positioned on one side or two adjacent sides of the circuit board 12. The light emitting device 10 is positioned at one corner of the circuit board 12 and faces the light detecting devices 11. The light detecting devices 11 are used for detecting infrared light emitted by the light emitting device 10. For example, in the exemplary embodiment, the light emitting device 10 is positioned at the top right corner of the circuit board 12.

The CPU 2 is configured to control the display unit 3 to display a plurality of menu options corresponding to the light detecting devices 11. The number of the menu options displayed will be the same as the number of the light detecting devices 11. As shown in FIG. 2, there are 8 menu options A-H respectively corresponding to the light detecting devices Q1-Q8. When one menu option is touched by a user, an infrared light path between the light emitting device 10 and the corresponding light detecting device 11 is obstructed, as a result, the corresponding light detecting device 11 does not detect the infrared light emitted by the corresponding light emitting device 10. The CPU 2 is configured to determine the menu option touched by the user when the corresponding light detecting device 11 detects an interruption of the infrared light emitted by the corresponding light emitting device 10 and thereby performs a function corresponding to the menu option.

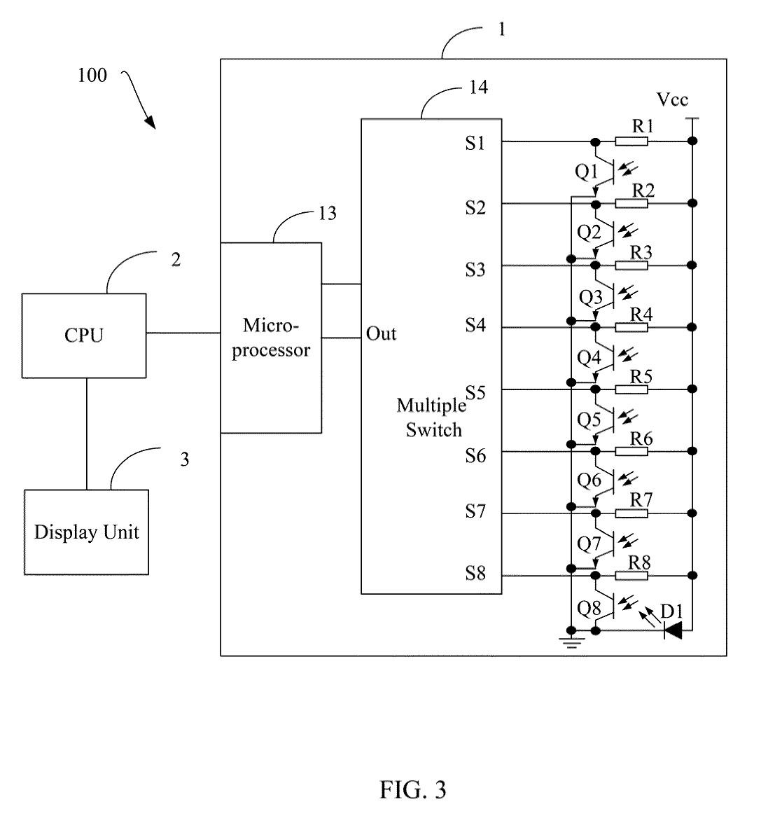

FIG. 3 is a block diagram showing the internal configuration of the electronic device 1. The infrared input device 1 further includes a micro-controller 13 connected to the CPU 2 and a multiple switch 14 connected to the micro-controller 13. The micro-controller 13 outputs a control signal to the multiple switch 14. The control signal may be repeatedly changed in a defined sequence, such as 000, 001, 010, 011, 100, 101, 110 and 111 respectively corresponding to control the multiple switch 14 to connect with one light detecting device 11. The multiple switch 14 includes a control signal input to receive the control signal from the micro-processor 13, a plurality of inputs (S1-S8) to receive the corresponding light detecting devices 11 (Q1-Q8), and an output connected with the micro-processor 13. The collectors of Q1-Q8 are commonly connected with a voltage source Vcc respectively via resistances R1-R8. The anode of the light emitting device 10 is further connected to the voltage source Vcc, and the cathode of the light emitting devices 10 is connected ground. The multiple switch 14 is configured to conduct one corresponding light detecting devices 11 and detect whether the corresponding infrared light path is obstructed.

Taking the control signal 000 as an example, the multiple switch 14 will conduct Q1 and detect whether the infrared light is received by Q1. If the infrared light path between Q1 and the D1 is not obstructed, the multiple switch 14 will be controlled to send a low voltage to the micro-controller 13. If the infrared light path between Q1 and D1 is obstructed, the multiple switch 14 will be controlled to send a high voltage to the micro-controller 13. The micro-controller 13 is further configured to determine which the menu option is touched when the high voltage is received.

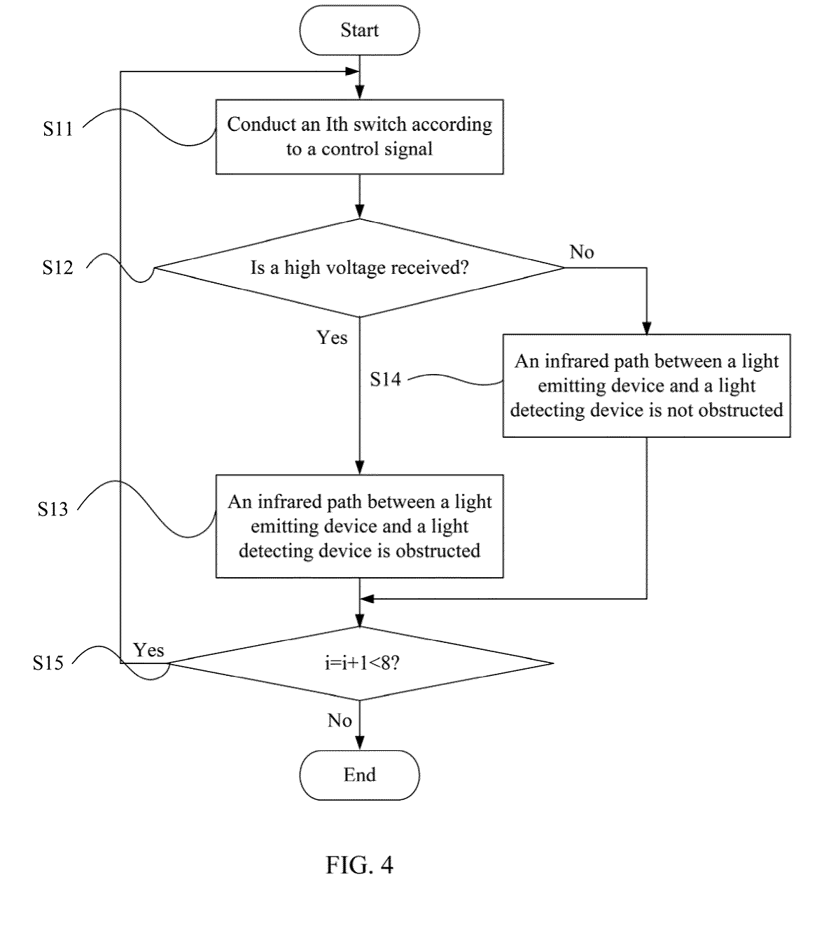

FIG. 4 is a flowchart implemented by the infrared input device 1. The flowchart shows one scan, scanning from Q1 to Q8.

In step S11, the multiple switch 14 controls the conduction with an Ith light detecting device 11. In the exemplary embodiment, the multiple switch 14 controls one of the light detecting devices 11 to detect the infrared light emitted by the light emitting device 10 according to a predetermined sequence. For example, the multiple switch 14 controls the light detecting devices 11 to conduct one by one from Q1 to Q8. In step S12, the micro-processor 13 determines if the high voltage is received, that is whether the infrared light is received. If yes, the procedure goes to step S13, otherwise, the procedure goes to S14. In step S13, the micro-processor 13 determines the infrared light path between the light emitting device 10 and the light detecting device 11 is obstructed, thereby the corresponding menu option is touched, and sends the high voltage to the CPU 2. The CPU 2 performs functions corresponding to the menu option being touched according to the high voltage, and the procedure goes to S15. In step S14, the micro-processor 13 determines the corresponding menu option is not touched by the user, and the procedure goes to S15. In step S15, the micro-processor 13 determines whether I+1 is less than or equal to the total number of the light detecting devices 11, e.g., 8. If yes, the procedure goes to step S11, otherwise, the procedure ends.

In order to avoid misoperation, during scanning, only when the time of the infrared light that is not received by the light emitting device 10 lasts for a predetermined time, the micro-processor 13 sends the high voltage to the CPU 2 to perform the functions corresponding to the menu option. Alternatively, during one scan, the micro-processor 13 detects the infrared light from one light emitting device 10 is not received by the light detecting device 11, and in the next one or two successive scans, the micro-processor 13 detects the infrared light is still not received by the same light detecting device 11, the micro-processor 13 sends the high voltage to the CPU 2 to perform the functions corresponding to the menu option.

Although the present disclosure has been specifically described on the basis of an exemplary embodiment thereof, the disclosure is not to be construed as being limited thereto. Various changes or modifications may be made to the embodiments without departing from the scope and spirit of the disclosure.

What is claimed is:

1. An electronic device with infrared touch input function, comprising:
a display unit defining an information display area;
an infrared input device comprising a circuit board having two pairs of oppositely disposed sides defining an open area corresponding in size and shape to the information display area,
at least one light emitting device positioned on one corner of the circuit board, configured for emitting infrared light;
a linear array of light detecting devices positioned on one side or two adjacent sides of the circuit board and faced to light emitting devices, configured for detecting infrared light emitted by the light emitting devices; and
a micro-processing unit configured for generating control signals to conduct one corresponding light detecting device, and determining whether the light detecting device receives the infrared light emitted by the light emitting device; and
a central processing unit(CPU) electronically connected with the infrared input device and the display unit, configured for controlling the display unit displaying a plurality of menu options corresponding to light detecting devices, determining whether the menu option is touched by determining whether the light detecting device receives the infrared light emitted by the light emitting device; and performing functions corresponding to the menu option when the menu option is touched.

2. The electronic device as claimed in claim 1, further comprising a multiple switch electronically connected between the light detecting devices and the micro-processor, configured for conducting the corresponding light detecting device according to the control signals generated by the micro-processor and sending a high voltage to the micro-processor when the corresponding light detecting device does not detect the infrared light emitted by the light emitting device.

3. The electronic device as claimed in claim 1, wherein the display unit is a flat panel display.

4. The electronic device as claimed in claim 1, wherein each light detecting device is an infrared phototransistor.

5. The electronic device as claimed in claim 1, wherein the at least one light emitting device is an organic light emitting diode.

6. The electronic device as claimed in claim 1, wherein the micro-processor sends a high voltage to the CPU to perform the functions corresponding to the menu option when a time duration of the infrared light that is not received by the light detecting device lasts for a predetermined time in one scan.

7. The electronic device as claimed in claim 1, wherein the micro-processor sends a high voltage to the CPU to perform the functions corresponding to the menu option, when the micro-processor detects that the infrared light from the light emitting device is not received by the same light detecting device in next one or two successive scans.

8. A method of controlling an electronic device with infrared touch input function, the electronic device comprising:
a display unit defining an information display area;
an infrared input device comprising a circuit board having two pairs of oppositely disposed sides defining an open area corresponding in size and shape to the information display area,
at least one light emitting device positioned on one corner of the circuit board, configured for emitting infrared light;
a linear array of light detecting devices positioned on one side or two adjacent sides of the circuit board and faced to light emitting devices, configured for detecting infrared light emitted by the light emitting devices; and
a micro-processing unit configured for generating control signals to conduct one corresponding light detecting device, and determining whether the light detecting device receives the infrared light emitted by the light emitting device; and
a micro-processing unit configured for generating control signals to conduct one of the light detecting devices
the method comprising:
controlling the display unit displaying a plurality of menu options corresponding to light detecting devices,
determining whether the menu option is touched by determining whether the light detecting device receives the infrared light emitted by the light emitting device; and
performing functions corresponding to the menu option when the menu option is touched.

9. The method of controlling an electronic device according to claim 8, wherein the electronic device further comprises a multiple switch electronically connected between the light detecting devices and the micro-processor, configured for conducting the corresponding light detecting device according to the control signals generated by the micro-processor and sending a high voltage to the micro-processor when the corresponding light detecting device does not detect the infrared light emitted by the light emitting device.

10. The method of controlling an electronic device according to claim 8, comprising: the micro-processor sending a high voltage to the CPU to perform the functions corresponding to the menu option when a time duration of the infrared light that is not received by the light detecting device lasts for a predetermined time in one scan.

11. The method of controlling an electronic device according to claim 8, comprising: the micro-processor sending a high voltage to the CPU to perform the functions corresponding to the menu option, when the micro-processor detects the infrared light from the light emitting device is not received by the same light detecting device in next one or two successive scans.

12. A method of controlling an electronic device with infrared touch input function, comprising:
conducting an Ith light detecting device;
determining whether the Ith light detecting device receives the infrared light emitted by a light emitting device;
determining a corresponding menu option is touched when the infrared light is not received; and
performing functions corresponding to the menu option being touched according to the signal.

13. The method of controlling an electronic device according to claim 12, comprising determining the corresponding menu option is untouched when the infrared light is received.

14. The method of controlling an electronic device according to claim 12, comprising:
determining whether I+1 is less than or equal to 8;
starting a new circular scan if the I+1 is equal to 8; or
conducting an (I+1)th light detecting device if the I+1 is less than 8.

15. The method of controlling an electronic device according to claim 12, comprising performing the functions corresponding to the menu option when a time duration of the infrared light that is not received by the light detecting device lasts for a predetermined time in one scan.

16. The method of controlling an electronic device according to claim 12, comprising performing the functions corresponding to the menu option, when the micro-processor detects that the infrared light from the light emitting device is not received by the same light detecting device in next one or two successive scans.
